(19) United States
(12) Patent Application Publication
(10) Pub. No.: US 2014/0049947 A1
(43) Pub. Date: Feb. 20, 2014

(54) Illuminated Apparel

(71) Applicants: Bridgit Lombard, Philadelphia, PA (US); Canice Harte, Park City, UT (US); William J. Reimann, Boise, ID (US); Qiong Li, Guangdong (CN)

(72) Inventors: Bridgit Lombard, Philadelphia, PA (US); Canice Harte, Park City, UT (US); William J. Reimann, Boise, ID (US); Qiong Li, Guangdong (CN)

(73) Assignee: Penguin Brands, Inc., Sharon Hill, PA (US)

(21) Appl. No.: 13/585,178

(22) Filed: Aug. 14, 2012

(51) Int. Cl. F21V 21/08; F21V 21/084; F21L 4/00

(52) U.S. Cl. 362/106; 362/103; 362/105

(57) ABSTRACT

Apparel, such as hats, headbands and gloves have one or more pockets, each holding an illumination device, and a pouch holding a battery, switch and circuitry for controlling the illumination display. Different color LEDs are used to distinguish the direction of travel of a wearer of the apparel under conditions of poor visibility.

### FIELD OF THE INVENTION

This invention relates to apparel, for example, sports apparel as used by runners, the apparel being actively illuminated to render the wearer more conspicuous during conditions of poor visibility.

### BACKGROUND

On average in the United States, a pedestrian is injured in an automobile accident every eight minutes. Even worse, a pedestrian is killed every 111 minutes. Between 1995 and 2010, pedestrian fatalities ranged from about 4,000 to over 5,000 per year, and pedestrian injuries ranged from about 70,000 to over 80,000. Statistics show, as expected, that most of the accidents occurred at night, on urban roads, and, surprisingly, at locations other than intersections.

Runners are especially vulnerable to serious road accidents involving motor vehicles. However, the odds of being injured or killed can be greatly reduced if proper precautions are exercised. High on the list of effective precautions is the wearing of high visibility sportswear which combines the advantages of modern fabrics with active, self-contained illumination devices to create a highly visible pedestrian, easily seen by motorists.

### SUMMARY

The invention concerns illuminated apparel. In one example, an article of apparel comprises a flexible substrate. A pocket is positioned on the substrate. An illumination device is positioned within the pocket. A light transmitting area is positioned overlying the illumination device, and a power source is operatively associated with the illumination device. In a particular example, the light transmitting area comprises an opening in the substrate. An open mesh may overlie the opening.

In another example, an article of illuminated apparel comprises a flexible substrate. A pocket is positioned on the substrate. An opening is positioned overlying the pocket. An illumination device is positioned within the pocket. The illumination device faces the opening for projecting light outwardly therefrom. A power source is operatively associated with the illumination device. In a particular example embodiment, the opening is in the substrate. An open mesh may overlie the opening.

The article may further comprise a pouch mounted on the substrate, the power source being positioned within the pouch. The power source may comprise an electrical battery. A pair of electrical conductors may extend between the electrical battery and the illumination device forming an electrical circuit. A switch may be positioned within the pouch, the switch being operatively associated with the electrical circuit for opening and closing the circuit.

By way of example the article may further comprise a lining attached to the substrate. The electrical conductors may be captured between the lining and the substrate. Furthermore, a snare may be mounted on the substrate, and the electrical conductors may be captured by the snare and thereby retained to the substrate.

In a particular example, the illumination device comprises at least one light emitting diode. In another example, the illumination device comprises a plurality of light emitting diodes encapsulated within a transparent polymer layer. Electronic circuitry may be positioned within the pouch, the circuitry being operatively associated with the switch, the electrical conductors, the electrical battery and the light emitting diodes for controlling illumination of the light emitting diodes in a plurality of lighting patterns. For example, the lighting patterns may be selected from the group consisting of flashing on and off, constantly on, and constantly off. The light emitting diodes may be mounted on one side of a backing lamina. The electrical conductors may be mounted on an opposite side of the backing lamina. In a particular example, the electrical conductors are retained to the opposite side of the backing lamina by a cinch surrounding the backing lamina and the transparent polymer layer. The backing lamina may have first and second ends oppositely disposed. A pair of electrical terminals is mounted on the backing lamina at the first end, the electrical terminals being electrically connected to the light emitting diodes, the electrical conductors being electrically connected to the electrical terminals. The cinch may be positioned surrounding the backing lamina and the transparent polymer layer at the second end of the backing lamina.

In one example embodiment, the article of illuminated apparel comprises a hat. An example hat may comprise a crown defining an internal volume, the crown having a perimeter defining an opening into the internal volume. A band is attached to the perimeter and surrounds the opening. A first pocket is positioned on the band. A first opening is positioned overlying the first pocket. A first illumination device is positioned within the first pocket and faces the first opening for projecting light outwardly therefrom. An electrical battery is operatively associated with the first illumination device. In a particular embodiment, the first opening is in the band. The example may further comprise an open mesh overlying the first opening. The example hat may further comprise a pouch mounted on the band. The electrical battery is positioned within the pouch.

In another example, the article of illuminated apparel comprises a headband. In a particular embodiment, the headband comprises a flexible substrate loop. A first pocket is positioned on the substrate loop. A first opening in the substrate loop is positioned overlying the first pocket. A first illumination device is positioned within the first pocket and faces the first opening for projecting light outwardly therefrom. An electrical battery is operatively associated with the first illumination device. In a particular embodiment, the opening is in the substrate loop. The embodiment may further comprise an open mesh overlying the first opening. The example headband may further comprise a pouch mounted on the substrate loop. The electrical battery is positioned within the pouch.

In another example, the article of illuminated apparel comprises a glove for receiving a hand, the hand having a palm and a back. In a particular embodiment, the example glove comprises a palm substrate positionable overlying the palm and a back substrate positionable overlying the back. The back substrate is attached to the palm substrate in overlying relation and forms a cavity therebetween. A pocket is positioned on the back substrate. An opening overlies the pocket. An illumination device is positioned within the pocket and faces the opening for projecting light outwardly therefrom. A power source is operatively associated with the illumination device. In a particular example, the opening is in the back substrate. An open mesh may overlie the opening. The example glove may further comprise a wrist skirt attached to the palm substrate and the back substrate. A pouch may be mounted on the wrist skirt, the electrical battery being positioned within the pouch. A pair of electrical conductors may extend between the electrical battery and the illumination device forming an electrical circuit. A switch may be positioned within the pouch. The switch is operatively associated with the electrical circuit for opening and closing the electrical circuit. A snare may be attached to one of the palm and back substrates. The electrical conductors are captured by the snare.

### BRIEF DESCRIPTION OF THE DRAWINGS

FIG. 1 is a top view of an example illumination device assembly used with the invention;

FIG. 2 is a bottom view of the illumination device assembly shown in FIG. 1;

FIG. 3 is an isometric front view of an example illuminated hat according to the invention;

FIG. 3A is a sectional view taken at line 3A-3A in FIG. 3;

FIG. 4 is an isometric rear view of the illuminated hat shown in FIG. 3;

FIG. 4A is a sectional view taken at line 4A-4A of FIG. 4;

FIG. 5 is a partial cut-away isometric front view of the illuminated hat shown in FIGS. 3 and 4;

FIGS. 6 and 7 are isometric front and rear views, respectively, of an example illuminated headband;

FIG. 8 is a back facing view of an example illuminated glove;

FIG. 9 is a palm facing view of the glove shown in FIG. 8;

FIG. 10 is a partial cut-away view of the glove shown in FIG. 8;

FIG. 11 is a back facing view of an example fingerless illuminated glove;

FIG. 12 is a palm facing view of the fingerless glove shown in FIG. 11;

FIG. 13 is a back facing view of an example illuminated mitten glove;

FIG. 14 is a palm facing view of an example illuminated combination mitten/finger glove;

FIG. 15 is a back facing view of the combination mitten/finger glove shown in FIG. 14; and

FIG. 16 is a detailed view of a portion of the headband shown in FIGS. 6 and 7.

### DETAILED DESCRIPTION

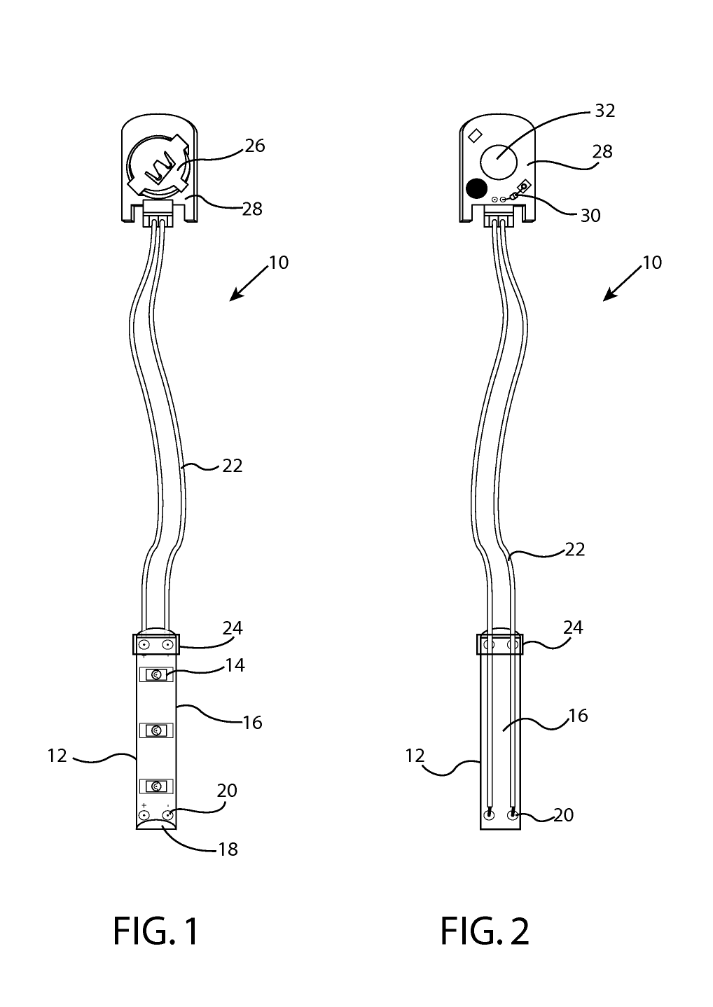

FIGS. 1 and 2 illustrate an example illumination device assembly 10 usable with illuminated apparel according to the invention, it being understood that other types of illumination device assemblies are also feasible. Illumination device assembly 10 comprises an illumination device 12, in this example, a plurality of light emitting diodes (LEDs) 14 mounted on one side of a backing lamina 16 and encapsulated within a transparent polymer layer 18. Exposed electrical terminals 20 extend from the opposite side of the backing lamina 16 affording electrical connection to the LEDs by a pair of electrical conductors 22. It is found advantageous to position terminals 20 at one end of the backing lamina 16 and run the electrical conductors 22 lengthwise along the lamina to its opposite end. A cinch 24 is then used to retain the conductors to the backing lamina 16, the cinch 24 being positioned surrounding the backing lamina and the polymer layer 18. Cinch 24 may be, for example, a heat shrinkable plastic band which cinches the conductors 22 to the backing lamina 16. Cinching the conductors at a point away from the terminals 20 help mitigate stress on the conductor-terminal connection to guard against fatigue failure.

Assembly 10 further includes a power source for the LEDs, in this example, an electric battery 26 mounted on a circuit board 28 having electronic circuitry 30. A switch 32 is also mounted on the circuit board 28. Electrical conductors 22 are connected to the circuit board 28. Circuitry 30 is operatively associated with the switch 32, the electrical conductors 22, the battery 26 and the LEDs 14 to form an electrical circuit between the battery 26 and the LEDs 14 that is controlled by the switch and the circuitry. The switch 32, in conjunction with the circuitry 30, operates as a selector for controlling illumination of the LEDs in a plurality of lighting patterns. For example, the LEDs may flash on and off at one or more frequencies, may be constantly on, or off, the selection being controlled by actuating the switch a number of times in succession. For example, starting from the condition wherein the LEDs 14 are off, a first click of the switch 32 will set the LEDs flashing rapidly, a second click will slow the rate of flashing, a third click will cause the LEDs to remain constantly on, and a fourth click will shut the LEDs off. Other combinations of illumination are also feasible. Variable illumination functions of this nature are effected by commercially available integrated circuits and thus need not be explained in any detail here.

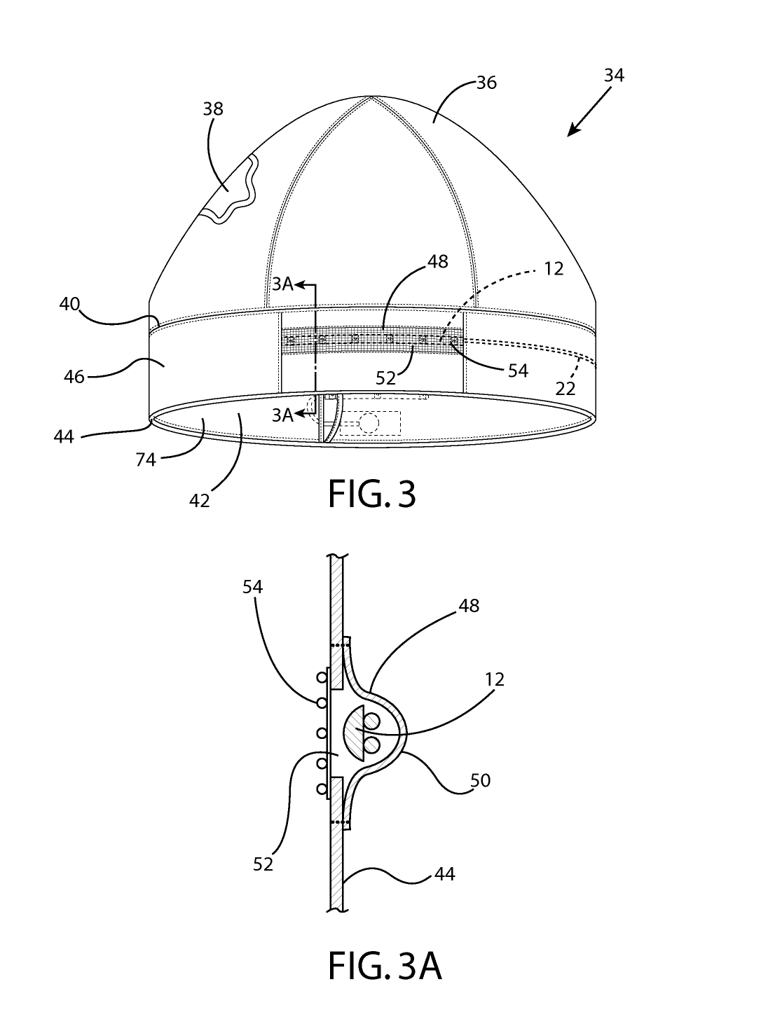

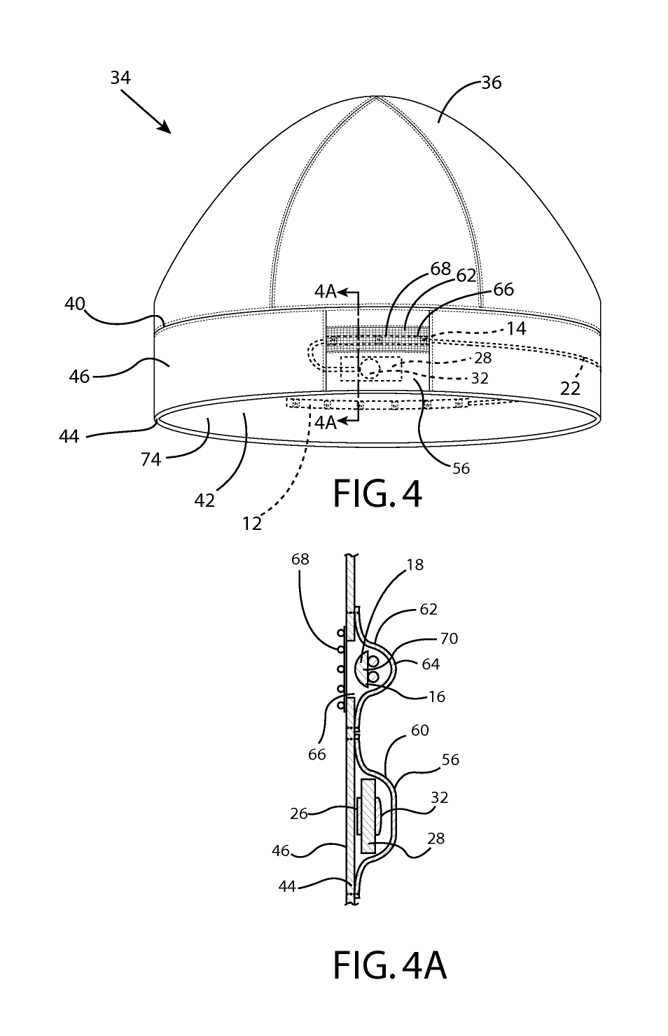

One example of illuminated apparel according to the invention is a hat 34, as shown in FIGS. 3 and 4. Hat 34 comprises a crown 36 which defines a volume 38. A perimeter 40 of the crown defines an opening 42 to the volume 38. A flexible substrate 44, in this example comprising a band 46, is attached to the perimeter 40 and surrounds the opening 42. As shown in FIG. 3A, a pocket 48 is positioned on the substrate 44. Pocket 48 is formed, for example, by attaching a layer of material 50 to the substrate, for example by stitching or adhesive. The illumination device 12 is positioned within the pocket 48 and a light transmitting area is positioned overlying the illumination device. In this example, the light transmitting area comprises an opening 52 in the substrate 44 (band 46) overlying the pocket 48. As part of the light transmitting area, an open mesh 54 overlies the opening 52 and helps retain the illumination device 12 within the pocket 48 while still allowing light to project outwardly from the pocket 48.

As shown in FIGS. 4 and 4A, hat 34 also comprises a pouch 56 mounted on the band 46. In this example, the pouch 56 is located diametrically opposite to the pocket 48 and holds the circuit board 28, battery 26 and switch 32. The switch 32 is actuated through the band 46 in normal use, but, as shown in FIG. 5, pouch 56 is provided with an opening 58 allowing the circuit board 28 to be removed to replace the battery 26. Hook and loop fasteners may be used to secure the opening 58 in the closed position. Pouch 56 is shown in cross section in FIG. 4A, and in this example comprises a layer of material 60 attached to the band 46, for example, by stitching or adhesive.

As shown in FIGS. 4 and 4A, the example hat 34 has a second pocket 62 also positioned on the band 46. Second pocket 62 is positioned diametrically opposite to the first pocket 48, and, as shown in cross section in FIG. 4A, comprises a layer of material 64 attached to the band 46. A light transmitting area, in the form of an opening 66 in the band is positioned overlying the pocket 62, and an open mesh 68 overlies the opening 66 to form part of the light transmitting area and help retain a second illumination device 70 within the pocket 62. Conductors 22 extend between the second illumination device 70 and the circuit board 28, switch 32 and battery 26, forming another electrical circuit. A liner 74 is attached to the band 46, the conductors 22 and 72 being captured between the liner and the band and presenting a neat appearance, with no visible conductors.

In this example, similar to the first illumination device 12, the second illumination device 70 comprises LEDs 14 mounted on a backing lamina 16 and encapsulated within a transparent polymer layer 18 (see FIGS. 1 and 2). The circuitry 30 and the battery 26 and switch 32 are operatively associated with the second illumination device 70 and control its lighting pattern as described above for the first illumination device 12. It is advantageous to have different color LEDs in the first and second pockets. For example, white LEDs may be positioned in the first pocket 48, and red LEDs may be positioned in the second pocket 62. When the hat 34 is then worn with the white LEDs facing frontward (the direction of travel) and the red LEDs facing rearward (as is customary on vehicles) the direction of motion of the wearer is readily determinable at a distance and in conditions of poor visibility.

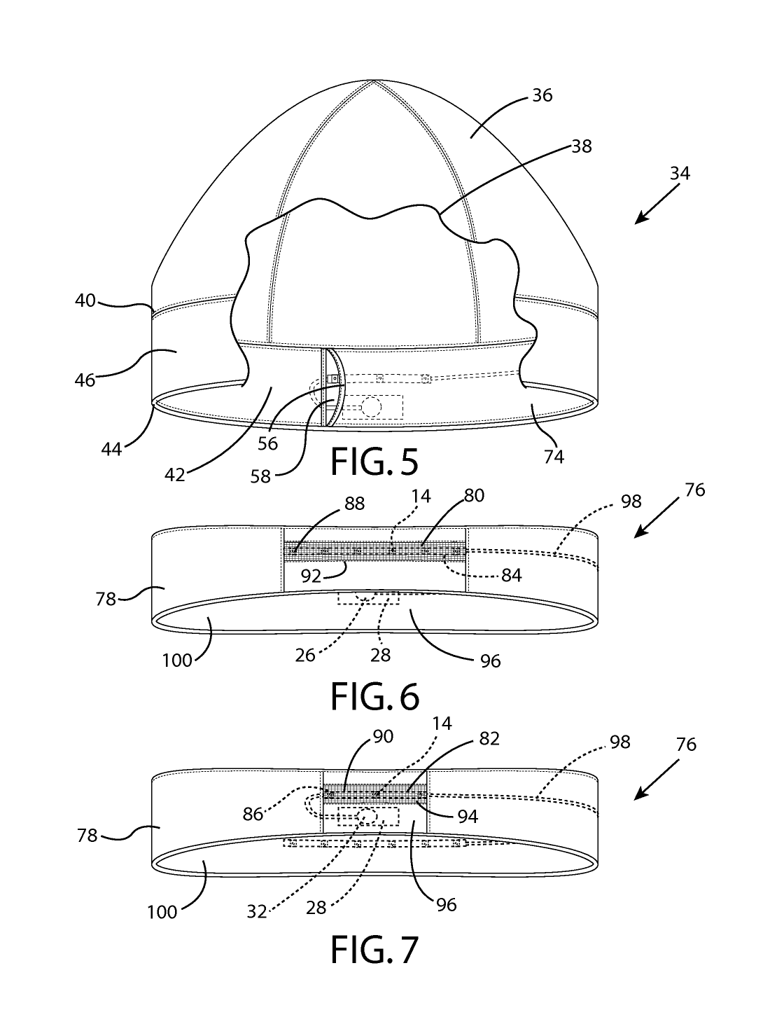

Another example of illuminated apparel according to the invention is a headband 76, as shown in FIGS. 6 and 7. Headband 76 comprises a flexible substrate loop 78. Similar to the hat 34, headband 76 has two pockets 80 and 82 arranged diametrically opposite to one another. Illumination devices 84 and 86 are positioned respectively in pockets 80 and 82. Light transmitting areas comprising openings 88 and 90 are positioned in the substrate loop overlying the pockets 80 and 82. Open mesh 92 and 94 overlies the openings 88 and 90 and helps retain the illumination devices 84 and 86 within the pockets 80 and 82 while still allowing light to project outwardly therefrom.

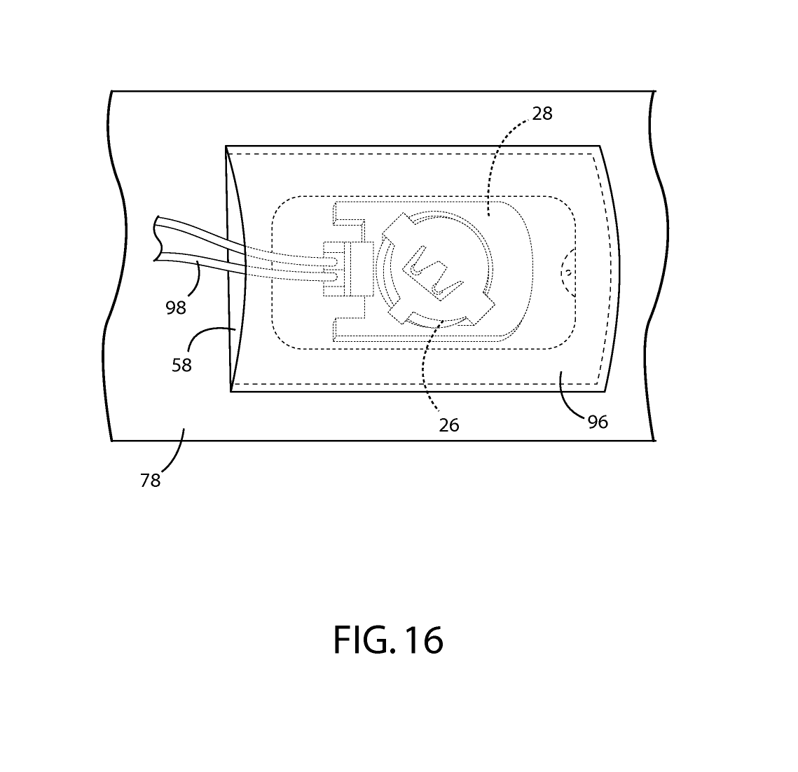

As shown in FIGS. 7 and 16, headband 76 also comprises a pouch 96 mounted on the substrate loop 78. In this example, the pouch 96 is located diametrically opposite to the pocket 80 and holds the circuit board 28, battery 26 and switch 32 operatively associated with the illumination devices 84 and 86. The switch 32 is actuated through the substrate loop 78 in normal use, but the pouch is provided with an opening 58 (similar to that shown in FIG. 5 for the hat 34) allowing the circuit board 28 to be removed to replace the battery 26. Hook and loop fasteners may be used to secure the opening in the closed position.

Conductors 98 extend between the illumination devices 84 and 86 and the circuit board 28, switch 32 and battery 26, forming an electrical circuit. A liner 100 is attached to the substrate loop 78, the conductors 98 being captured between the liner and the loop and presenting a neat appearance, with no visible conductors.

In this example headband 76, similar to the hat 34, the first and second illumination devices 84 and 86 comprises LEDs 14 mounted on a backing lamina 16 and encapsulated within a transparent polymer layer 18 (see FIGS. 1 and 2). The circuitry 30 and the battery 26 and switch 32 are operatively associated with the illumination devices 84 and 86 and control their lighting pattern as described above for the first illumination device 12. It is advantageous to have different color LEDs in the first and second pockets. For example, white LEDs may be positioned in the first pocket 80, and red LEDs may be positioned in the second pocket 82. When the headband 76 is then worn with the white LEDs facing frontward (the direction of travel) and the red LEDs facing rearward (as is customary on vehicles) the direction of motion of the wearer is readily determinable at a distance and in conditions of poor visibility.

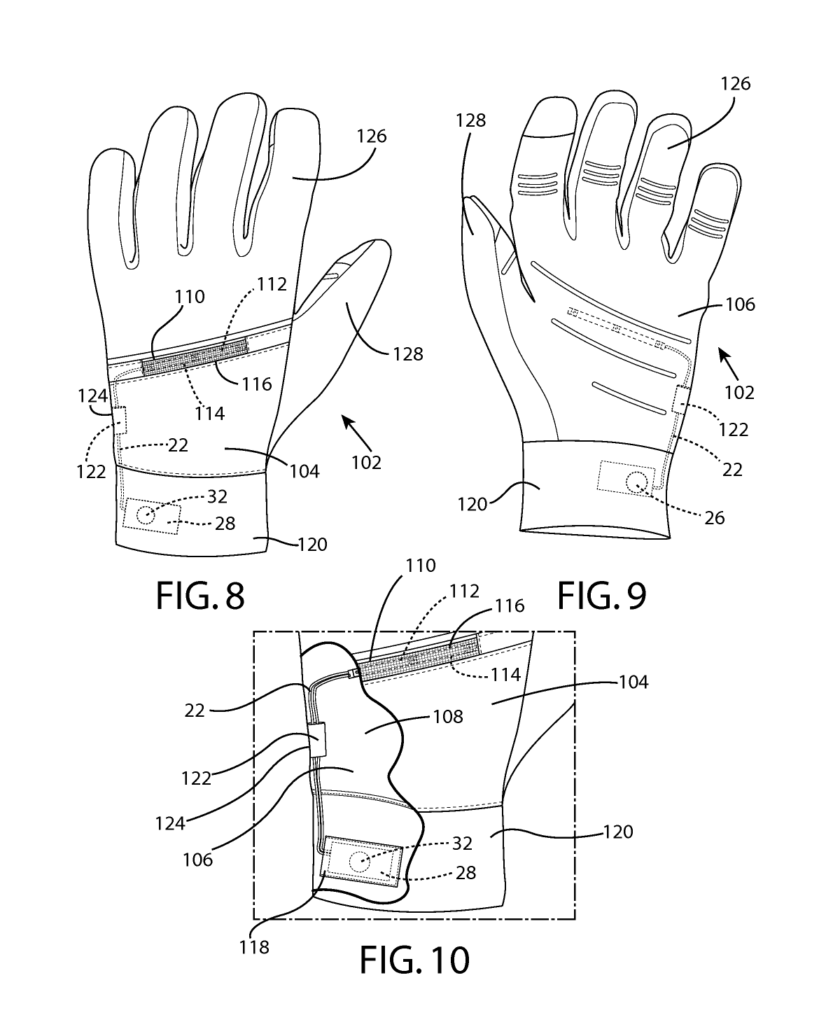

Another example of illuminated apparel according to the invention comprises a glove 102 as shown in FIGS. 8-10. Glove 102 is formed of a back substrate 104 (which overlies the back of a wearer's hand) attached to a palm substrate 106 to form a cavity 108 for receiving the hand of a wearer. In this example glove 102, a pocket 110 is positioned on the back substrate 104. (Pocket 110 has the same structure as the pocket illustrated in FIG. 3A.) An illumination device 112 is positioned within pocket 110, and a light transmitting area comprising an opening 114 in the back substrate 104 is positioned overlying the pocket 110. An open mesh 116 is attached to the back substrate 104 overlying the opening 114 to help retain the illumination device 112 within the pocket 110. In this example glove the illumination device 112 is arranged to project light substantially perpendicular to the back substrate 104.

The illumination device 112 in this example again comprises a plurality of LEDs 14 mounted on a backing lamina 16 and encapsulated within a transparent polymer layer 18 as illustrated in FIGS. 1 and 2. Electrical conductors 22 form a circuit between the LEDs and the battery 26, switch 32 and circuit board 28. The circuitry 30 on the circuit board in conjunction with the switch 32 and battery 26 controls the lighting pattern of the LEDs as described above. As shown in FIG. 10 the battery, switch and circuit board are contained within a pouch 118 mounted on a wrist skirt 120 that is attached to the back substrate 104 and palm substrate 106. (Pouch 118 has the same structure as the pouch illustrated in FIG. 4A.) Electrical conductors 22 extend from the pouch 118 through the cavity 108 and into the pocket 110 to connect the illumination device 112 to its power and control source. A snare 122 is positioned within cavity 108 and is attached to one of or both the back substrate 104 and the palm substrate 106. For example, the snare 122 may be sewn into the seam 124 between the back and palm substrates as shown in FIG. 10. The snare 122 captures and secures the conductors 22 within the cavity 108 to prevent interference when the gloves are donned. Switch 32 may be actuated through the material forming the wrist skirt 120.

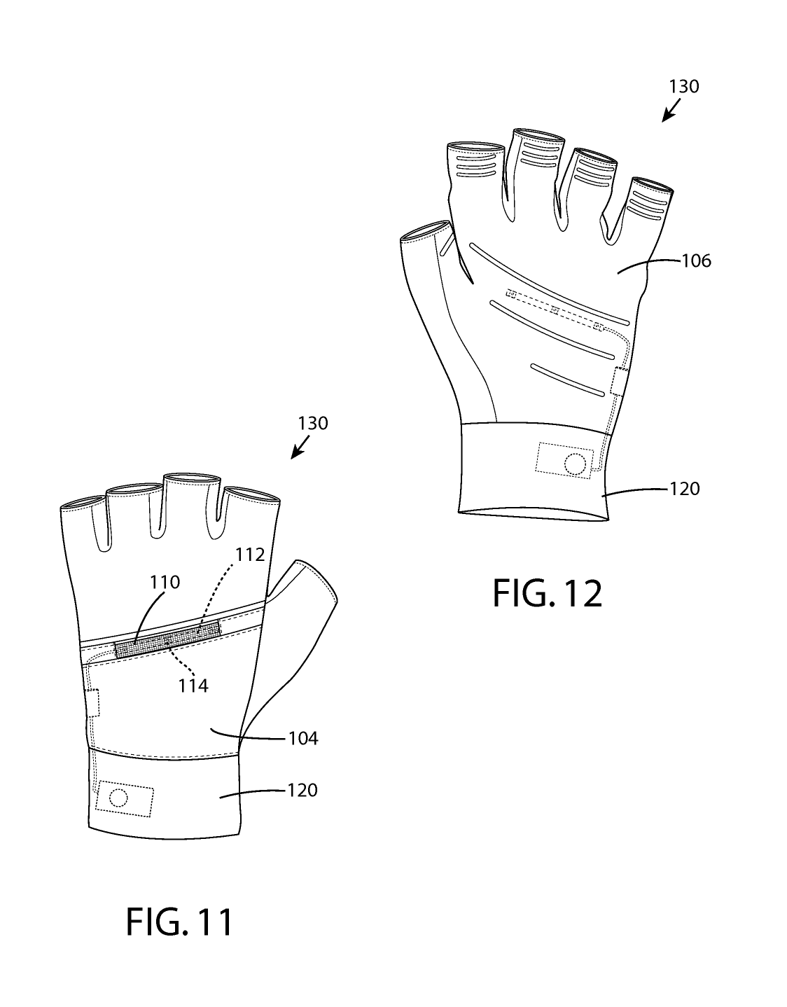

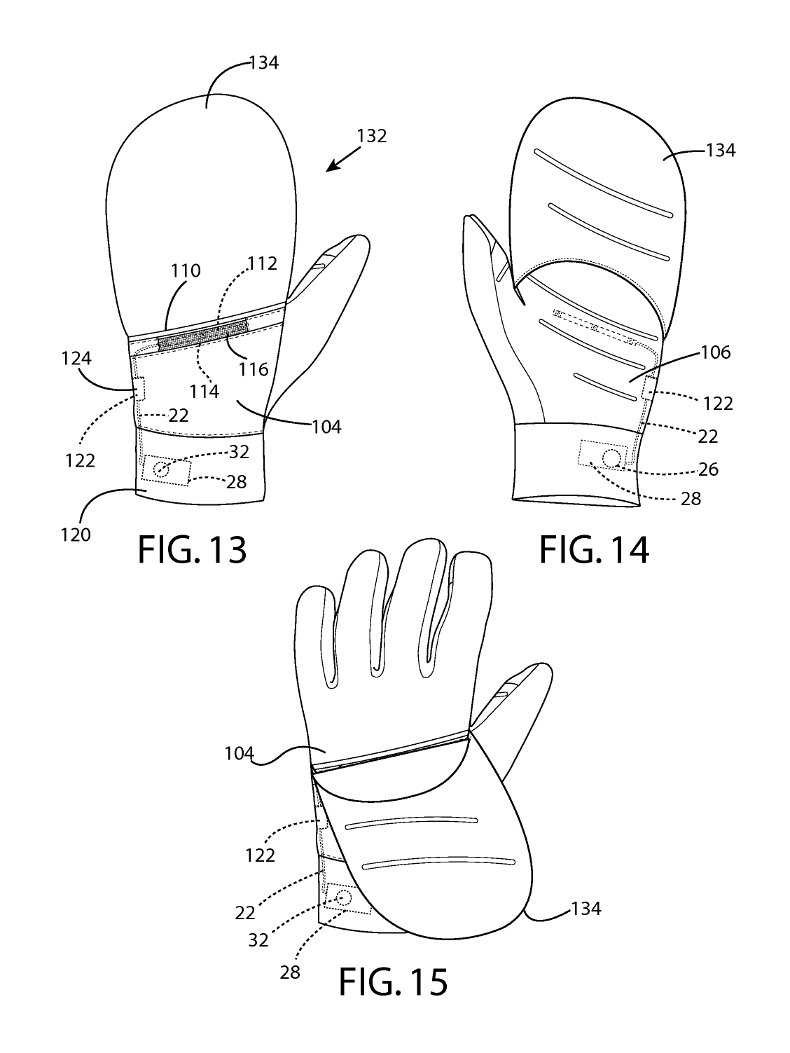

Various illuminated glove embodiments are feasible. FIGS. 8-10 show a full glove 102 having a plurality of finger sheaths 126 and a thumb sheath 128 attached to the back and palm sheaths 104 and 106. Full illuminated gloves are advantageous for running or cycling in cold weather. “Fingerless” illuminated gloves 130, as shown in FIGS. 11 and 12 are adapted for use in hot weather. Another illuminated glove embodiment 132, illustrated in FIGS. 13-15, comprises a mitten, and includes a finger compartment 134. The finger compartment 134 may be attached to the back substrate 104 and the palm substrate 106 to form a traditional mitten as shown in FIG. 13. Alternately, as shown in FIGS. 14 and 15, the finger compartment 134 may be attached only to one of the back or palm substrates 104 and 106, and removable from the fingers by extracting the fingers and folding the finger compartment back to free the fingers when dexterity is required. By way of example, FIG. 15 shows the finger compartment 134 attached to the back substrate 104 and folded back to free the fingers of the wearer. It is understood that the finger compartment may be used with either full or fingerless gloves.

Illuminated apparel according to the invention may comprise substrates formed of woven, non-woven and knitted materials and fabrics. Synthetic and natural fibers, as well as blends and combinations of the two fibers, can be used to advantage to form the materials and fabrics used in the illuminated apparel according to the invention.

Illuminated apparel as disclosed herein is expected to increase the visibility of runners and thereby reduce the number of injuries and fatalities suffered.

1. An article of apparel, said article comprising:
a flexible substrate;
a pocket positioned on said substrate;
an illumination device positioned within said pocket;
a light transmitting area positioned overlying said illumination device;
a power source operatively associated with said illumination device.

2. The article according to claim 1, wherein said light transmitting area comprises an opening in said substrate.

3. The article according to claim 2, further comprising an open mesh overlying said opening.

4. An article of apparel, said article comprising:
a flexible substrate;
a pocket positioned on said substrate;
an opening positioned overlying said pocket;
an illumination device positioned within said pocket and facing said opening for projecting light outwardly therefrom;
a power source operatively associated with said illumination device.

5. The article according to claim 4, wherein said opening is in said substrate.

6. The article according to claim 4, further comprising an open mesh overlying said opening.

7. The article according to claim 4, further comprising a pouch mounted on said substrate, said power source being positioned within said pouch.

8. The article according to claim 7, wherein said power source comprises an electrical battery.

9. The article according to claim 8, further comprising:
a pair of electrical conductors extending between said electrical battery and said illumination device forming an electrical circuit;
a switch positioned within said pouch, said switch being operatively associated with said electrical circuit for opening and closing said circuit.

10. The article according to claim 9, further comprising a lining attached to said substrate, said electrical conductors being captured between said lining and said substrate.

11. The article according to claim 9, further comprising a snare mounted on said substrate, said electrical conductors being captured by said snare and thereby retained to said substrate.

12. The article according to claim 9, wherein said illumination device comprises at least one light emitting diode.

13. The article according to claim 9, wherein said illumination device comprises a plurality of light emitting diodes encapsulated within a transparent polymer layer.

14. The article according to claim 13, further comprising electronic circuitry positioned within said pouch, said circuitry being operatively associated with said switch, said electrical conductors, said electrical battery and said light emitting diodes for controlling illumination of said light emitting diodes in a plurality of lighting patterns.

15. The article according to claim 14, wherein said lighting patterns are selected from the group consisting of flashing on and off, constantly on, and constantly off.

16. The article according to claim 12, wherein said light emitting diodes are mounted on one side of a backing lamina.

17. The article according to claim 16, wherein said electrical conductors are mounted on an opposite side of said backing lamina.

18. The article according to claim 17, wherein said electrical conductors are retained to said opposite side of said backing lamina by a cinch surrounding said backing lamina and said transparent polymer layer.

19. The article according to claim 18, wherein:
said backing lamina has first and second ends oppositely disposed;
a pair of electrical terminals are mounted on said backing lamina at said first end, said electrical terminals being electrically connected to said light emitting diodes, said electrical conductors being electrically connected to said electrical terminals; and
wherein said cinch is positioned surrounding said backing lamina and said transparent polymer layer at said second end of said backing lamina.

20. The article according to claim 4, wherein said apparel comprises a hat.

21. The article according to claim 4, wherein said apparel comprises a headband.

22. The article according to claim 4, wherein said apparel comprises a glove.

23. A hat, comprising:
a crown defining an internal volume, said crown having a perimeter defining an opening into said internal volume;
a band attached to said perimeter and surrounding said opening;
a first pocket positioned on said band;
a first opening positioned overlying said first pocket;
a first illumination device positioned within said first pocket and facing said first opening for projecting light outwardly therefrom;
an electrical battery operatively associated with said first illumination device.

24-41. (canceled)

42. A headband, comprising:
a flexible substrate loop;
a first pocket positioned on said substrate loop;
a first opening positioned overlying said first pocket;
a first illumination device positioned within said first pocket and facing said first opening for projecting light outwardly therefrom;
an electrical battery operatively associated with said first illumination device.

43-60. (canceled)

61. A glove for receiving a hand, said hand having a palm and a back, said glove comprising:
a palm substrate positionable overlying said palm;
a back substrate positionable overlying said back, said back substrate attached to said palm substrate in overlying relation and forming a cavity therebetween;
a pocket positioned on said back substrate;
an opening overlying said pocket;
an illumination device positioned within said pocket and facing said opening for projecting light outwardly therefrom;
a power source operatively associated with said illumination device.

62-77. (canceled)
